(19) United States
(12) Patent Application Publication
(10) Pub. No.: US 2006/0281871 A1
(43) Pub. Date: Dec. 14, 2006

(54) Polymer composition

(75) Inventor: Udo Steffl, Weidenberg (DE)

Correspondence Address: VENABLE LLP, P.O. BOX 34385, WASHINGTON, DC, 20043-9998, US

(73) Assignee: REHAU AG+CO, REHAU (DE)

(21) Appl. No.: 10/571,464

(22) PCT Filed: Sep. 13, 2003
(86) PCT No.: PCT/EP03/10201

§ 371 Date: Mar. 13, 2006

(51) Int. Cl. C08L 77/00

(52) U.S. Cl. 525/426

(57) ABSTRACT

The invention relates to a polymer composition which is suitable for the production of bodywork trimming parts whose flexion is <15 mm in a heat sag test at 250° C. over a time period of 30 minutes. Said composition comprises a polyamide, a syndiotactic monovinyl aromatic homo-polymer or co-polymer, a polystyrene copolymer or a polystyrene graft copolymer and an impact resistance modifier.

The present invention relates to a polymer composition as well as to car body trimming parts produced with this composition.

Once they are assembled, car body trimming parts of this type can withstand temperatures of approximately 200° C., which occur during the cathode immersion-painting, without experiencing deformation. To achieve a Class A surface, they furthermore do not contain glass fiber admixture.

In the field of automobile manufacture, body trimming parts such as bumpers or fenders are generally made of metal. However, plastic materials are used more and more to save weight and achieve cost advantages in case of minor collision damages. Fiber-reinforced, unsaturated polyester and polyurethane materials are used as duroplastics. For cost reasons, the most commonly used thermoplastic materials are elastomer-modified polypropylenes, wherein compositions based on different polyesters as well as polymer blends on the basis of polyphenylene oxide and polyamide are used to meet higher optical and mechanical requirements.

Car body trimming parts of plastic can either be painted separately from the metal car body (offline), or they can be integrated into the car body painting operation. In the latter case, a distinction is made between a plastic part that is assembled before (online) or one that is assembled after the cathode immersion painting (inline). The temperatures for the online painting operation range from 195 to 210° C. and require a corresponding thermal stability of the materials used.

Different methods can be used for determining the dimensional stability of materials under heat. The dimensional stability HDT [heat deflection temperature] according to the German Institute of Standards DIN 53461 is the temperature at which the bending sample, positioned with both sides inside a liquid heat-transfer means and heated up uniformly, shows a defined deflection when subjected to a specific, centrally applied force.

The dimensional stability under heat according to Martens, as defined in DIN 53462, is characterized by the temperature at which the bending sample that is heated in air with a predetermined heating speed is deflected by a predetermined amount under the effect of a force. The Vicat softening temperature as defined in DIN ISO 306 is the temperature at which a fixed penetration body, under the effect of a force of 10 or 50N and with uniformly rising temperature, penetrates the surface of a plastic sample body to a depth of 1 mm.

The so-called heat sag test has proven to be effective in practical operations as measure for evaluating the dimensional stability of a car body trimming part subjected to heat. For this test, a 4 mm thick tension test bar according to ISO 3167, produced with the injection-molding technique according to DIN ISO 294, is clamped horizontally into a device and the deviation in millimeters from the horizontal line is then determined for a predetermined temperature and following a predetermined interval.

If a car body contains side-by-side mounted metal and plastic parts, it makes sense for reasons of cost and color consistency to paint the plastic parts also with the standard primer and paint used for metal parts.

As mentioned before, traditional polymers do not meet the thermal stability requirements for applying the primer, meaning the requirements for the cathode immersion painting, especially if a higher impact resistance at subzero temperatures must be met together with a low thermal longitudinal expansion coefficient and a Class A surface texture.

In recent years, attempts have been made to develop correspondingly suitable polymer compositions, such as listed in the following examples.

Thermoplastic polymer compositions are known, for example, from U.S. Pat. No. 3,379,792. In this reference, a polymer composition of polyphenylene ether and polyamide is described, which exhibits improved flow properties as compared to pure polyphenylene oxide.

However, the workability of compositions of this type, in particular when using the injection-molding technique, continues to remain poor with achievable MFR [material flow rate] values of less than 10 g/min (280° C./5 kg). Owing to the glass transition temperature, which is insufficient in the final analysis, and the amorphous character of the polyphenylene ether, the polymer compositions according to reference U.S. Pat. No. 3,379,792 have a low rigidity level and poor non-sag behavior at temperatures higher than 180° C. Combined with the restricted flow properties, surface problems in the form of waviness, unrest, and contrasts occur, in particular with large, thin-walled components. These problems require an involved and costly reworking of the plastic parts.

Blended compositions on the basis of syndiotactical polymers are known, for example from reference WO 99/14273, which describes a composition essentially comprising the following:
(a) a syndiotactical mono vinyl aromatic polymer;
(b) a polyamide;
(c) a compatibility enhancer for (a) and (b);
(d) a rubber-type elastomer
(e) a domain-forming caoutchouc; and
(f) a functionalized polyolefin caoutchouc.

However, traditional products made from these polymer materials have disadvantages with respect to the heat non-sag behavior when subjected to stress near or above the 200° C. level. Thus, when using the heat sag test at temperatures of 250° C. over a period of 30 min, the deviation of the sample body from the horizontal line is more than 50 mm.

The known thermoplastic materials on the basis of elastomer-modified polypropylene and polyester mixtures do not in any way meet the temperature requirements for online-paintable car body trimming parts while blends on the basis of polyphenylene oxide and polyamide meet these requirements only insufficiently. Furthermore, the flow properties as well as the optical appearance are not satisfying for practical operations.

It is therefore the object of the present invention to make available a polymer composition which shows a deviation of less than 15 mm from the horizontal line on the sample body when subjected to the heat sag test at 250° C./30 min. and which is suitable for producing car body parts that combine a high surface quality, good impact resistance, and low thermal expansion in longitudinal direction with high rigidity and which can be produced cheaply. In particular, the polymer composition used for these car body trimming parts should have a high flow rate in the melt.

According to the invention, this object is solved with a polymer composition comprising:
(A) a polyamide
(B) a syndiotactic mono vinyl aromatic homo-polymer or copolymer
(C) a polystyrene copolymer or a polystyrene graft copolymer and
(D) an impact resistance modifier.

The invention is explained in further detail in the following: The polymer composition according to the invention contains 100 weight percentages of the component A and is a thermoplastic polyamide, comprising lactams, e.g. E caprolactam, capryl lactam, lauric lactam and oenanthic lactam as polyamide-forming monomers, as well as mixtures of these monomers. Further polyamide-forming monomers used can be dicarbonic acids, such as alkane dicarbonic acids with 6 to 12 carbon atoms, e.g. azelaic acid, pimelic acids, adipic acid, suberic acid, sebacic acid, as well as terephthalic acid and isophthalic acid and diamines such as alkyl diamines with 4 to 12 alkyl groups, for example tetramethylene diamine, hexamethylene diamine and octamethylene diamine, or 2,2-bis(4-aminophenyl)-propane, bis(4-aminocyclohexyl)methane, m-xylylene diamine or bis(4-aminophenyl)methane, as well as mixtures of diamines with dicarbonic acids in optional combinations and ratios relative to each other, such as hexamethylene diammonium adipate, tetramethylene diammonium adipate or hexamethylene diammonium terephthalate.

Particularly preferred polyamides are polyamide 6, polyamide 66, polyamide 46, polyamide MXD6 and mixtures of these polyamides.

The syndiotactic monovinyl aromatic homo-polymer or copolymer (component B) can be a syndiotactic polystyrene homo-polymer or copolymer, preferably with 80-100% syndiotactic diades, an average molecular weight of 50,000 to 2,500,000 and a melting point of 160 to 310° C. The weight percentage of the components (B), relative to the component (A), can be between 0.1 and 80 parts.

The polystyrene copolymer (C) can be a poly(styrene-co-acrylnitrile), poly(styrene-co-methylvinyloxazoline), poly(styrene-co-maleic acid anhydride), poly(styrene-co-methyl-vinyloxazoline-co-acrylnitrile), or poly(styrene-co-maleic acid imide) copolymer. The polystyrene copolymer (C) can furthermore be a mixture of two or more of the aforementioned polymers.

The component (C) can also be a polystyrene graft copolymer, created from syndiotactic polystyrene by grafting on maleic acid anhydride or ithaconic acid anhydride or (meth) acrylic acid and their esters.

The weight percentage of the component (C), relative to the component A, can range from 0.1 to 50 parts.

Particularly preferred are poly(styrene-co-maleic acid imide) copolymers, for which the maleic acid anhydride groups are imidized only partially and which have an average molecular weight between 80,000 and 200,000. The share of the maleic acid anhydride groups of the poly(styrene-co-maleic acid imide)copolymers not undergoing reaction can range from 0.1 to 10 mol % while the share of maleic imide groups can range from 0.1 to 50 mol %. The glass transition temperature is between 150 and 195° C.

Especially preferred are poly(styrene-co-maleic acid imide)copolymers with glass transition temperatures of 195° C. The component (C) of the polymer composition according to the invention in this case not only acts as phase mediator for (A) and (B), but in particular also as high-temperature modifier. As a result, the heat non-sag behavior near or above 200° C. is improved considerably.

The impact resistance modifier (D) can be a natural caoutchouc polybutadien, polyisoprene, polyisobutylene, a mixed polymer of the butadien and/or the isoprene with styrene and other co-monomers, a hydrated mixed polymer and/or a mixed polymer, created through grafting with maleic acid anhydride, ithaconic acid anhydride, (meth)acrylic acid and their esters. The impact resistance modifier (D) can also be a grafted caoutchouc with a cross-linked elastomer core, which consists of butadien, isoprene, or alkylacrylates and is provided with a graft envelope of polystyrene, a non-polar or polar olefin homo-polymer and copolymer such as ethylene-propylene, ethylene-propylene-dien, and ethylene-octen or ethylene-vinylacetate caoutchouc; or a non-polar or polar olefin homo-polymer and copolymer, created through grafting with maleic acid anhydride, ithaconic acid anhydride, (meth) acrylic acid and their esters. The impact resistance modifier (D) can also be a carbonic acid functionalized copolymer such as poly(ethene-co(meth)acrylic acid) or poly(ethene-co-1-olefin-co-(meth)acrylic acid), wherein the 1-olefin is an alkene or a non-saturated (meth) acrylic acid ester with more than 4 atoms, including those copolymers in which the acid groups are partially neutralized with metal ions.

Particularly preferred are mixed polymers of the butadien with styrene, functionalized through grafting with maleic acid anhydride, non-polar or polar olefin homo-polymers and copolymers, created through grafting with maleic acid anhydride, and carbonic acid functionalized copolymers with poly(ethene-co-(meth)acrylic acid) or poly(ethene-co-1-olefin-co-(meth)acrylic acid), in which the acid groups are partially neutralized with metal ions.

The weight percentages of the components (D), relative to the component (A), can range from 0.1 to 50 parts.

The polymer composition of the car body trimming parts can contain, if necessary, up to 200 percentages by weight of additives, relative to the component (A), in the form of up to 5 percentages by weight of sliding agents or processing agents, up to 5 percentages by weight pigments, up to 2 percentages by weight nucleation means, up to 1 percentage by weight stabilizers, up to 2 percentages by weight expanding agents, up to 2 percentages by weight antistatic agents, up to 100 percentages by weight processing oils, up to 100 percentages by weight filler materials and/or flame retarding agents and up to 50 percentages by weight of conductive additives.

Mixing conductive additives into polymers or polymer compositions makes it possible to paint the polymer part in an electrostatic field. In that case, the electrostatically charged paint particles follow the electrical field lines from the painting pistol to the substrate to be painted, resulting in the advantage of a particularly uniform paint application, meaning “cloud formations” are avoided, as well as a considerable reduction in the so-called paint overspray. Since the conductive additives can considerably influence the mechanical properties of a polymer composition, their selection and the technique used for working them in are extremely important.

Preferred conductive additives are conductive soot, conductive graphite, metal particles, carbon nano tubes, PAN (polyacrylonitrile) carbon fibers, nickelized carbon fibers, recycled carbon fibers, metal-coated glass fibers, or ceramic fibers (whisker). Particularly preferred is conductive soot with particle sizes ranging from 10 to 60 nm and a nitrogen adsorption ranging from 30 to 1500 m²/g, wherein the DBPA adsorption (dibutylphthalat adsorption—oil absorption capacity) is between 40 and 450 cm³/100 g.

The conductive soot can be worked in either as pure powder or in pearl form or by using a pre-composition of the conductive soot, on the basis of component (A).

Used as filler materials are, for example, magnesium hydroxide, calcium carbonate, talcum, wollastonite, silicic acids and silicates with ionic layer charges, modified through cation or anion exchange, preferably suspended in oil or fat components.

Glass fibers can also be added in special cases.

The polymer composition according to the invention and used for car body trimming parts can be produced in a manner known per se by mixing and heating the individual components in a processing unit, preferably under the effect of shearing forces. The extrusion or injection-molding technique can be used for producing shaped parts or semi-finished goods.

The polymer composition according to the invention is preferably used in the automobile manufacturing process for producing car body trimming parts. Car body trimming parts of this type include fenders, bumpers, said panels, tank flaps and/or outer door shells. These parts are preferably produced with the injection-molding and/or the gas internal pressure technique.

The following examples explain the present invention, wherein the invention is not limited to these examples.

The weight percentages for the composition are provided relative to 100 weight percentages of the component (A) and are as follows for the examples and/or comparative examples below:

| Example 1: | Example 2: | Example 3: | Example 4: |
|---|---|---|---|
| 100 T polyamide | 100 T polyamide | 100 T polyamide | 100 T polyamide |
| (component A) [1] | (component A) [1] | (component A) [2] | (component A) [2] |
| 42 T syndiotactic PS | 42 T syndiotactic PS | 42 T syndiotactic PS | 42 T syndiotactic PS |
| (component B) [3] | (component B) [3] | (component B) [3] | (component B) [3] |
| 8 T polystyrene copolymers | 8 T polystyrene copolymers | 8 T polystyrene copolymers | 8 T polystyrene copolymers |
| (component C) [4] | (component C) [4] | (component C) [4] | (component C) [4] |
| 17 T impact resistance | 17 T impact resistance | 17 T impact resistance | 17 T impact resistance |
| modifier [5] | modifier [6] | modifier [5] | modifier [6] |

| Comparison example 1: | Comparison example 2 | Comparison example 3: |
|---|---|---|
| 100 T polyamide [1] | 100 T polyamide [7] | PA/ABS blend [10] |
| 42 T PPE [8] | 55 T syndiotactic PS [3] | |
| 17 T impact resistance | 18 impact resistance | |
| modifier [9] | modifier [6] | |
| 8 T maleic acid anhydride | 4 T oil-stretched ethylene | |
| grafted PPE | octen copolymers | |
| | 9 T fumaric acid grafted | |
| | PPE | |

[1] Polyamide used for Example 1: polyamide 66, melting point 260° C., specific density 1.12 g/cm³
[2] Polyamide used for Example 2: polyamide 46, melting point 295° C., specific density 1.18 g/cm³
[3] Syndiotactic polystyrene: Mw[average value]=300,000; syndiotacticity 96%
[4] Polystyrene copolymers: poly(styrene-co-maleic acid imide), Mw=150,000 content of maleic imide groups 39 mol %, glass transition temperature 195° C.
[5] Impact resistance modifier: styrene ethylene/butadien styrene triblock copolymer; MFR [g/10 min] less than 1 at 230° C./5 kg; styrene/EB ratio 30/70
[6] Impact resistance modifier: maleic acid anhydride grafted ethylene octen copolymers, MFR [g/10 min] 1.2 at 190° C./2.16 kg; average grafting degree
[7] Polyamide used for the comparison example 2: polyamide 6, melting point 220° C., specific density 1.10 g/cm³
[8] PPE: polyphenylene ether, viscosity 0.40 dl/g
[9] Impact resistance modifier: maleic acid anhydride grafted styrene ethylene/butadien-styrene triblock copolymer; MFR [g/10 min] 22 at 230° C./5 kg; styrene/EB ratio 30/70
[10] Triax 1180 by the company Monsanto.

### COMPARISON EXAMPLE 2

Granulate type syndiotactic polystyrene [3], polyamide [7], impact resistance modifier [6], oil-stretched ethylene octen copolymers and fumaric acid grafted PPO are metered at temperatures higher than 270° C. into a double-screw extruder with metering device for granulates. The mixture is then melted, is extruded continuously, and is cut. The resulting thermoplastic mixture has the properties as listed in the table.

### EXAMPLE 1

Granulate type syndiotactic polystyrene [3], polystyrene copolymers [4], polyamide [1] and impact resistance modifier [5] are metered at temperatures higher than 270° C. into a double-screw extruder with metering device for granulates. The mixture is then melted, is extruded into ropes, and is cut. The resulting thermoplastic mixture has the properties as listed in the table.

### EXAMPLE 2

Granulate type syndiotactic polystyrene [3], polystyrene copolymers [4], polyamide [1], and impact resistance modifier [6] are metered at temperatures higher than 270° C. into a double-screw extruder with metering device for granulates. The mixture is then melted, is extruded continuously, and is cut. The resulting thermoplastic mixture has the properties as listed in the table.

### EXAMPLE 3

Granulate type syndiotactic polystyrene [3], polystyrene copolymers [4], polyamide [2] and impact resistance modifier [5] are metered at temperatures higher than 295° C. into a double-screw extruder with metering device for granulates. The mixture is then melted, is extruded continuously, and is cut. The resulting thermoplastic mixture has the properties as listed in the table

### EXAMPLE 4

Granulate type syndiotactic polystyrene [3], polystyrene copolymers [4], polyamide [2] and impact resistance modifier [6] are metered at temperatures higher than 295° C. into a double-screw extruder with metering device for granulates. The mixture is then melted, is extruded continuously, and is cut. The resulting thermoplastic mixture has the properties as listed in the table

The following Table 1 shows the mechanical properties of the composition according to the invention, whereas Table 2 shows the mechanical properties according to the comparison examples 1-3.

TABLE 1

| Property | Unit | Standard | Example 1 | Example 2 | Example 3 | Example 4 |
|---|---|---|---|---|---|---|
| modulus of | [MPa] | ISO 527 | 2670 | 2430 | 2597 | 2490 |
| elasticity | | | | | | |
| impact | [kJ/m^{2]} | ISO 179 | OBr* | OBr* | 80.0 | 56.0 |
| resistance | | | | | | |
| VicatB50 | [° C.] | DIN ISO | 180 | 171 | 190 | 184 |
| | | 306 | | | | |
| HeatSag | [mm] | | 9 | 9 | 4 | 6 |
| Test | | | | | | |
| [deflection | | | | | | |
| at 250° C.] | | | | | | |
| longitudinal | [x10⁻⁶] | DIN 53752 | 84.3 | 89.0 | 63.0 | 82.0 |
| expansion | | | | | | |
| coefficient | | | | | | |
| 23° C./80° C | | | | | | |
| MFR | [g/10 min] | DIN ISO | 26.7 | 23.7 | 92.8** | 14.5** |
| [280° C./5 kg] | | 1133 | | | | |

*OBr = without break
** at 300° C./5 kg
*** nb = not known

TABLE 2

| | | | Comparison | Comparison | Comparison |
|---|---|---|---|---|---|
| Property | Unit | Standard | Example 1 | Example 2 | Example 3 |
| modulus of | [MPa] | ISO 527 | 2100 | 2330 | 1950 |
| elasticity | | | | | |
| impact | [kJ/m²] | ISO 179 | OBr* | OBr* | OBr* |
| resistance | | | | | |
| VicatB50 | [C.] | DIN ISO 306 | 172 | 140 | 114 |
| heat sag test | [mm] | | 24 | can no longer | 83 |
| (deflection at | | | | be measured | |
| 250° C.] | | | | (deviation | |
| | | | | 90° C.) | |
| longitudinal | [x10^{6]} | DIN 53752 | 90.0 | 107.0 | 90.0 |
| expansion | | | | | |
| coefficient | | | | | |
| 23 ° C./80° C. | | | | | |
| MFR | [g/10 min] | DIN ISO 1133 | 12.0 | 24.7 | 10.0** |
| [280° C./5 kg] | | | | | |

* without break
** at 250° C./5 kg

1. A polymer composition, suitable for producing car body trimming parts, wherein the composition has a deflection of less than 15 mm when subjected to a heat sag test at 250° C. over a period of 30 minutes.

2. The polymer composition, comprising
(A) a polyamide
(B) a syndiotactic monovinyl aromatic homo-polymer or copolymer;
(C) a polystyrene copolymer or polystyrene graft copolymer;
(D) an impact resistance modifier.

3. The polymer composition as defined in claim 2, wherein the component (A) is selected from the group polyamide 6, polyamide 66, polyamide 46, polyamide MXD6, or a mixture of these polyamides.

4. The polymer composition as defined in claim 2, wherein the component (B) is a syndiotactic polystyrene homo-polymer or copolymer with 80-100% syndiotactic diades, an average molecular weight of 50,000 to 2,500,000 and a melting point of 160 to 310° C.

5. The polymer composition as defined in claim 2, wherein the component (C) is selected from the group poly(styrene-co-acrylnitrile); poly(styrene-co-methylvinyloxazoline); poly(styrene-co-maleic acid anhydride); poly(styrene-co-methylvinyloxazoline-co-acrylnitrile); poly(styrene-co-maleic acid imide) copolymer or a mixture of these copolymers.

6. The polymer composition as defined in claim 2, wherein the polystyrene grafted copolymer in the component (C) is generated from syndiotactic polystyrene by grafting on maleic acid anhydride or ithaconic acid anhydride or (meth)acrylic acid and their esters.

7. The polymer composition as defined in claim 2, wherein the component (D) is selected from the group mixed polymers of the butadien and/or isoprene with styrene and other co-monomers, hydrated products and/or products created through grafting with maleic acid anhydride, ithaconic acid anhydride, (meth)acrylic acid and their esters; non-polar or polar olefin homo-polymers and copolymers created through grafting with maleic acid anhydride, ithaconic acid anhydride, (meth)acrylic acid, and their esters, or carbonic acid functionalized copolymers such as poly(ethene-co-(meth)acrylic acid) or poly(ethene-co-1-olefin-co-(meth)acrylic acid), wherein the acid groups are partially neutralized with metal ions.

8. The polymer composition as defined in claim 2, wherein the component (C) is a poly(styrene-co-maleic acid imide) copolymer with a maleic acid anhydride groups rest which has not undergone reaction.

9. The polymer composition as defined in claim 8, wherein the share of the maleic acid anhydride groups which has not undergone reaction ranges from 0.1 to 10 mol % for the poly(styrene-co-maleic acid imide) copolymers.

10. The polymer composition as defined in claim 8, wherein the glass transition temperature for the poly(styrene-co-maleic acid imide) copolymers is between 150 and 195° C.

11. The polymer composition as defined in one of the prceding claim 2, additionally comprising the admixture of up to 200 weight %, relative to the component (A), in the form of up to 5 weight percentages auxiliary sliding and processing agents, up to 5 weight percentages pigments, up to 2 weight percentages nucleation agents, up to 1 weight percentage stabilizers, up to 2 weight percentages expanding agents, up to 2 weight percentages antistatic agents, up to 100 weight percentages processing oils, up to 100 weight percentages filler materials and/or flame-retarding agents.

12. The polymer composition as defined in claim 2, wherein the composition additionally contains glass fibers.

13. The polymer composition as defined in claim 2, wherein the composition additionally comprises conductive additives.

14. The polymer composition as defined in claim 13, wherein the conductive additive is conductive soot, having particle sizes ranging from 10 to 60 nm, a nitrogen adsorption between 30 and 1500 m²/g, and a dibutylphthalat adsorption between 40 and 450 cm³/100 g.

15. The polymer composition as defined in claim 1, wherein the polymer composition is the same as defined in claim 2.

16. The use of a polymer composition as defined in claim 2 for producing body trimming parts for the manufacture of automobiles.

17. Car body trimming parts according to claim 1, wherein these body trimming parts comprise fenders, bumpers, side panels, tank flaps, sill boards and/or outer door shells.

18. The production of car body trimming parts according to claim 1, using the injection-molding technique and/or the gas inside pressure technique.

19. Car body trimming parts according to claim 2, wherein these body trimming parts comprise fenders, bumpers, side panels, tank flaps, sill boards and/or outer door shells.

20. The production of car body trimming parts according to claim 2, using the injection-molding technique and/or the gas inside pressure technique.
